(19) United States
(12) Patent Application Publication
(10) Pub. No.: US 2007/0035252 A1
(43) Pub. Date: Feb. 15, 2007

(54) Current bushing system for a lamp

(76) Inventors: Jurgen Becker, Berlin (DE); Thomas Bittmann, Friedberg (DE); Bodo Mittler, Stadtbergen (DE); Andreas Ponnier, Berlin (DE)

Correspondence Address: OSRAM SYLVANIA INC, 100 ENDICOTT STREET, DANVERS, MA, 01923, US

(21) Appl. No.: 11/501,038

(22) Filed: Aug. 9, 2006

(30) Foreign Application Priority Data
Aug. 10, 2005 (DE) 10 2005 038 066.2

(51) Int. Cl. H01J 17/04

(52) U.S. Cl. 313/633

(57) ABSTRACT

The invention discloses a current bushing system for a lamp, having molybdenum foils, which are embedded in a gas-tight manner in at least one end section of the lamp and on which, in each case at two opposite narrow sides, an outer power supply line and an electrode or an outer power supply line and an inner power supply line are arranged. According to the invention, the power supply lines and/or electrodes have, at least in sections, a coating which is designed such that the fusion behavior of the power supply lines and/or electrodes is impaired in the coating region.

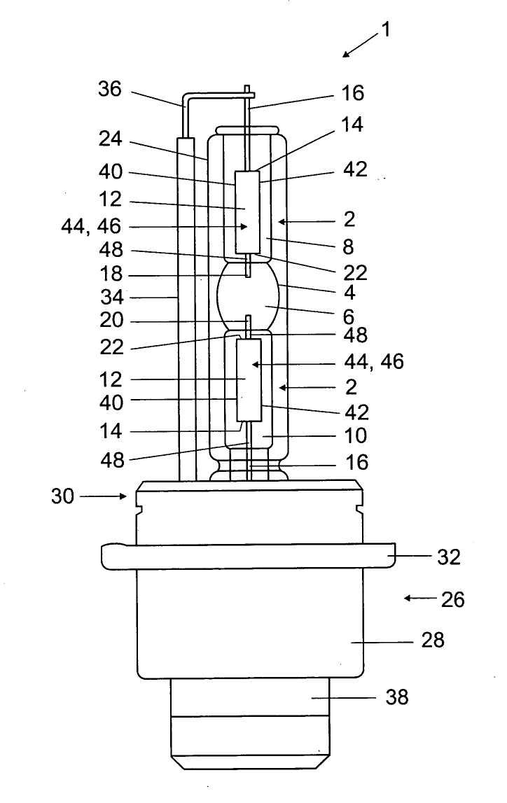

### TECHNICAL FIELD

The invention relates to a current bushing system for a lamp, having molybdenum foils, which are embedded in a gas-tight manner in at least one end section of the lamp and on which, in each case at two opposite narrow sides, an outer power supply line and an electrode or an outer power supply line and an inner power supply line are arranged, and to a lamp provided with such a current bushing system.

### BACKGROUND ART

Such current bushing systems are used, for example, for electrical power supply lines in pinch seals, consisting of quartz or hard glass, of discharge lamps, halogen incandescent lamps or the like.

Since the glass of the pinch seal has a substantially lower coefficient of thermal expansion than the power supply lines provided for the purpose of supplying electrical energy to a luminous means or electrode system arranged within the lamp vessel, thin molybdenum foils with sufficient ductility are often used which, despite the different coefficients of thermal expansion of glass and molybdenum, allow for a gas-tight electrical power supply. In the case of such solutions, which are known, for example, from DE 197 09 928 A1, the two opposite ends of the molybdenum foils are each welded to an inner and an outer power supply wire consisting of molybdenum or an outer power supply wire and an electrode, and the resultant current bushing system is positioned in the lamp vessel end such that the inner power supply lines or electrodes protrude into the interior of the lamp vessel and the outer power supply lines protrude out of said lamp vessel. Then, the glass is heated at the lamp vessel end and is pinched, for example by means of pinching jaws with the current bushing system in a gas-tight manner to form a pinch seal. The molybdenum foils are used firstly for producing the electrically conductive connection between the luminous means arranged within the lamp vessel or the electrode and the outer power supply lines and secondly ensure gas-tight sealing of the lamp vessel.

One disadvantage with such current bushing systems is firstly that, owing to the different coefficients of thermal expansion of the lamp glass and the current bushings or electrodes consisting of metal, in particular in the case of lamps having a high thermal load, a significant increase in stress in the pinch seal may result until the breakage and therefore premature failure of the lamp. It is furthermore disadvantageous that the power supply lines, owing to the high operating temperatures of the lamp, tend towards the formation of molybdenum oxides, for example MoO₂, MoO₃, the oxides initially forming on the outer power supply lines and then progressing to the molybdenum foils. Owing to this temperature-dependent oxide formation, the volume of the mentioned components is increased and causes an additional increase in stress in the pinch seal which may lead to breakage and therefore premature failure of the lamp.

### DESCRIPTION OF THE INVENTION

The invention is based on the object of providing a current bushing system for a lamp and a lamp equipped with such a current bushing system, in the case of which stresses in the region in which the power supply lines and electrodes are embedded are reduced with improved temperature and oxidation stability in comparison with conventional solutions.

This object is achieved by a current bushing system for a lamp, having molybdenum foils, which are embedded in a gas-tight manner in at least one end section of the lamp and on which, in each case at two opposite narrow sides, an outer power supply line and an electrode or an outer power supply line and an inner power supply line are arranged, whereby said power supply lines and/or electrodes have, at least in sections, a coating which is designed such that the fusion behavior of the power supply lines and/or electrodes is impaired in the coating region. Particularly advantageous embodiments of the invention are described in the dependent claims.

The current bushing system according to the invention for a lamp has molybdenum foils, which are embedded in a gas-tight manner in at least one end section of the lamp and on which, in each case at two opposite narrow sides, an outer power supply line and an electrode or an outer power supply line and an inner power supply line are arranged. According to the invention, the power supply lines and/or electrodes have, at least in sections, a coating which is designed such that the fusion behavior of the power supply lines and/or electrodes is impaired in the coating region. That is to say the above-mentioned coating of the power supply lines and/or electrodes is designed such that the adhesion of the power supply lines and/or electrodes to the lamp vessel or to the lamp vessel material is reduced by the coating. Owing to the fusion behavior of the power supply lines and electrodes to the glass of the lamp vessel which is impaired by the coating, stresses resulting from different coefficients of thermal expansion of the lamp glass and the metal of the power supply lines or electrodes can be compensated for by elastic movements of the power supply lines or electrodes in the glass, and therefore breakages in the embedding region can be avoided, with the result that premature failure of the lamp is prevented. In addition, the oxidation stability of the power supply lines and electrodes and therefore the temperature stability of the current bushing system is improved owing to the coating, with the result that the lamp life is further extended.

In accordance with one particularly preferred exemplary embodiment, the molybdenum foils are provided with a coating which improves the fusion behavior, i.e. increases the adhesion of the molybdenum foils to the lamp vessel material, the layer thickness of the coating of the molybdenum foils with the layer thickness of the coating of the power supply lines and/or electrodes having a layer thickness ratio in the range of from approximately 1:2 to 1:40. That is to say the layer thickness of the coating of the outer and inner supply lines or the electrodes is substantially greater than the layer thickness of the coating the he molybdenum foils. As a result, stresses caused by the different coefficients of thermal expansion of the lamp glass and the metal of the power supply lines or electrodes can be compensated for within the coating.

It has proven to be particularly advantageous if the coating of the molybdenum foils essentially has a layer thickness of approximately 10 to 100 nm, preferably of 50 nm. Owing to this relatively thin layer thickness, the hold and the sealing effect of the molybdenum foils in the glass of the lamp vessel is improved and, as a result, the life of the lamp is extended to a considerable extent.

The coating of the power supply lines and/or electrodes preferably has a layer thickness of essentially approximately 200 to 400 nm, preferably of 300 nm. With a layer thickness for the coating in this range, the fusion behavior of the outer and inner power supply lines or the electrodes on the glass of the lamp vessel is impaired.

In one exemplary embodiment according to the invention, the coating contains ruthenium, a ruthenium alloy or a ruthenium/molybdenum eutectic.

In accordance with one further preferred exemplary embodiment, the coating contains at least one oxide from the group consisting of zirconium oxide, yttrium oxide, titanium oxide or a corresponding mixed oxide.

The coating is preferably applied so as to substantially cover the entire area of the surface of the current bushing system.

As a result, high-density fusion of the molybdenum foil in the lamp glass and oxidation protection of the power supply lines and electrodes are achieved. In one variant according to the invention, individual surface regions of the current bushing system can be kept free, for example in order to improve weldability. Furthermore, the arc-side electrode tips can be kept free, at least in sections, from coating material by a mask or the coating can be subsequently removed in this region, for example by means of laser or chemical stripping.

In one preferred embodiment of the invention, the coating is applied with different layer thicknesses on the current bushing system. For example, the molybdenum foils may have a thinner coating on one side in the region of the welded joints in order to improve weldability. In this case, a layer thickness of approximately 20 nm has proven to be particularly advantageous.

In one preferred exemplary embodiment, the coated surface comprises a mixture of the base material and the coating material. The resultant surface is very rough and, as a result, can improve the interlacing effect between the metal of the current bushing system and the lamp glass and allows for high-density embedding of the molybdenum foils and a defined hold of the power supply lines and electrodes in the pinch seal.

The coating is preferably applied to the current bushing system by means of a vacuum coating process, for example by means of a sputtering process. In this case, by means of a bias applied to the current bushing system, the ions located in the plasma are accelerated in a defined manner onto the base material. In the process, a mixture of coating material and base material can be achieved, at least in sections, in the zones of the current bushing system which are close to the surface.

In one alternative variant of the invention, the coating is applied to the current bushing system by means of an electroplating process or using sandblasting technology. In the case of coating using sandblasting technology, the coating material can be admixed to the sandblasting means, for example corundum (aluminum oxide particles) or silica sand (SiO₂ particles), in particle form and applied with this sandblasting means. As a result, essentially uniform coating of the current bushing system is achieved in a simple manner.

The lamp according to the invention, for example a high-pressure discharge lamp, has at least one current bushing system in which the power supply lines and/or electrodes have, at least in sections, a coating impaired by the fusion behavior.

### BRIEF DESCRIPTION OF THE DRAWING

The invention will be explained in more detail below with reference to a preferred exemplary embodiment. The single figure shows a schematic illustration of a high-pressure discharge lamp having a current bushing system according to the invention.

### BEST MODE FOR CARRYING OUT THE INVENTION

The figure shows a schematic illustration of a high-pressure discharge lamp 1 having a current bushing system 2 according to the invention. The high-pressure discharge lamp 1 has a discharge vessel 4 consisting of quartz glass and having an interior 6 and two diametrically arranged, sealed end sections 8, 10, in which in each case a foil 12 consisting of doped molybdenum is embedded for the gas-tight current bushing. The molybdenum foils 12 are connected, at a first narrow side 14, to an outer power supply line 16 consisting of doped molybdenum. Two diametrically arranged electrodes 18, 20 consisting of doped tungsten, which are each connected to a second narrow side 22 of the molybdenum foils 12 and between which a gas discharge is formed during lamp operation, protrude into the interior 6 of the discharge vessel 4. An ionizable filling is enclosed in the interior 6 of the discharge vessel 4, said ionizable filling comprising high-purity xenon gas and a plurality of metal halides and possibly mercury. The discharge vessel 4 is surrounded by an outer bulb 24, which consists of quartz glass, which is provided with ultraviolet radiation-absorbing dopants. The high-pressure discharge lamp 1 also has a lamp base 26, which bears the discharge vessel 4 and the outer bulb 24. The lamp base 26 has a base housing 28 which is cylindrical in sections, consists of an electrically insulating plastic and has a fixing section 30 on the lamp side for the purpose of accommodating the lamp 1 in the base housing 28. The fixing section 30 has a flange 32, which is annular at least in sections, for the purpose of fixing the high-pressure discharge lamp 1 in a lampholder (not illustrated). The outer power supply line 16 of that end section 8 of the discharge vessel 4 which is remote from the base is connected to an electrical connection ring 38 of the base 26 via a current return line 36, which is surrounded by an insulating sleeve 34, while the outer power supply line 16 which is near to the base is connected to an inner contact pin (not illustrated) of the high-pressure discharge lamp 1.

The molybdenum foils 12 used each have an approximately rectangular basic shape, whose edge is formed by the mutually opposite narrow sides 14, 22 and by two side edges 40, 42 which extend perpendicularly with respect to the narrow sides 14, 22. The surface 44 of the molybdenum foils 12 preferably has a convex curvature, its thickness continuously decreasing, starting from its longitudinal axis, towards the two side edges 40, 42, with the result that the molybdenum foils 12 form an approximately lanceolated cross section and, as a result, allow for a homogenous stress profile in the end sections 8, 10 of the high-pressure discharge lamp 1. A coating 46 consisting of ruthenium, improving the fusion behavior and having a layer thickness of approximately 50 nm is applied to the molybdenum foils 12. Owing to this relatively thin layer thickness, the adhesion and sealing effect of the molybdenum foils 12 in the end sections 8, 10 of the discharge vessel 4 are improved and, as a result, the life of the lamp 1 is extended to a considerable extent.

According to the invention, the power supply lines 16 and the electrodes 18, 20 are provided, in sections, with a coating 48 which impairs the fusion behavior. Owing to the fusion behavior of the power supply lines 16 and the electrodes 18, 20 on the glass of the discharge vessel 4 which is impaired by the coating, the stresses resulting from the different coefficients of thermal expansion of the lamp glass and the metal of the power supply lines or electrodes in the glass are compensated for by elastic movements of the power supply lines or electrodes in the glass, with the result that premature failure of the high-pressure discharge lamp 1 is prevented. In addition, the oxidation stability and therefore the temperature stability of the current bushing system 2 is improved owing to the coating 48, with the result that the lamp life is further extended. In the exemplary embodiment shown, the layer thickness of the coating 48 of the power supply lines 16 and the electrodes 18, 20 is essentially approximately 300 nm, i.e. the layer thickness of the coating 46 of the molybdenum foils 12 has a layer thickness ratio of approximately 1:6 in relation to the layer thickness of the coating 48 of the power supply lines 16 and the electrodes 18, 20.

In one variant (not illustrated) of the invention, the coating 48 contains a ruthenium alloy, a ruthenium/molybdenum eutectic or at least one oxide from the group consisting of zirconium oxide, yttrium oxide, titanium oxide or a corresponding mixed oxide.

In the current bushing system shown, the coatings 46, 48 are applied so as to cover the entire area of the surface of the molybdenum foils 12 or the power supply lines 16 and the electrodes 18, 20. As a result, high-density fusion of the molybdenum foils 12 in the lamp glass and oxidation protection of the power supply lines 16 and electrodes 18, 20 are achieved.

In one variant (not illustrated), individual regions of the current bushing system 2 are kept free, for example in order to improve weldability. In particular, the arc-side electrode tips can be kept free of coating material, at least in sections, by a mask, or the coating 48 can be subsequently removed in this region, for example by means of laser or chemical stripping. Furthermore, the coating 46, 48 can be applied to the current bushing system 2 with different layer thicknesses. For example, the molybdenum foils 12 may have a thinner coating on one side in the region of the welded joints. In this case, a layer thickness of approximately 20 nm has proven to be particularly advantageous.

In the exemplary embodiment shown, the coatings 46, 48 are applied to the current bushing system 2 by means of a vacuum coating process (PVD process) using sputtering technology. In this case, owing to a bias applied to the current bushing system 2, the ions located in the plasma are accelerated in a defined manner onto the base material, i.e. the current bushing system 2. As a result, a mixture of coating material and base material is achieved in the zones of the current bushing system 2 which are close to the surface. The resultant surface is very rough and, as a result, can improve the interlacing effect between the metal of the current bushing system 2 and the lamp glass and allows for high-density embedding of the molybdenum foils 12 and a defined hold of the power supply lines 16 and electrodes 18, 20 in the end sections 8, 10 of the high-pressure discharge lamp 1. The molybdenum foils 12 consist of molybdenum or of molybdenum which has been doped with a yttrium/cerium mixed oxide.

In one alternative variant of the invention, the coating 46, 48 is applied to the current bushing system 2 by means of an electroplating process or using sandblasting technology. In the case of a coating using sandblasting technology, the coating material can be admixed in particle form to the sandblasting means, for example corundum (aluminum oxide particles) or silica sand (SiO₂ particles) and applied with said sandblasting means. As a result, an essentially uniform coating of the current bushing system 2 is achieved in a simple manner.

The current bushing system according to the invention is not restricted to the described high-pressure discharge lamp; rather the current bushing system can be used in different lamp types known from the prior art. It is essential to the invention that a coating impairing the fusion behavior is applied, at least in sections, to the power supply lines and/or electrodes such that stresses owing to the different coefficients of thermal expansion, which may lead to breakage of the lamp, are avoided in this region.

The invention discloses a current bushing system 2 for a lamp 1, having molybdenum foils 12, which are embedded in a gas-tight manner in at least one end section 8, 10 of the lamp 1 and on which, in each case at two opposite narrow sides 14, 22, an outer power supply line 16 and an electrode 18, 20 or an outer power supply line and an inner power supply line 16 are arranged. According to the invention, the power supply lines 16 and/or electrodes 18, 20 have, at least in sections, a coating 48 which is designed such that the fusion behavior of the power supply lines 16 and/or electrodes 18, 20 is impaired in the coating region.

1. A current bushing system for a lamp, having molybdenum foils, which are embedded in a gas-tight manner in at least one end section of the lamp and on which, in each case at two opposite narrow sides, an outer power supply line and an electrode or an outer power supply line and an inner power supply line are arranged, whereby said power supply lines and/or electrodes have, at least in sections, a coating which is designed such that the fusion behavior of the power supply lines and/or electrodes is impaired in the coating region.

2. The current bushing system as claimed in claim 1, the layer thickness of a coating of the molybdenum foils with the layer thickness of the coating of the power supply lines and/or electrodes having a layer thickness ratio in the range of from approximately 1:2 to 1:40.

3. The current bushing system as claimed in claim 2, the coating of the molybdenum foils essentially having a layer thickness of approximately 10 to 100 nm, preferably of 50 nm.

4. The current bushing system as claimed in claim 1, the coating of the power supply lines and/or electrodes essentially having a layer thickness of approximately 200 to 400 nm, preferably of 300 nm.

5. The current bushing system as claimed in claim 1, the coating containing ruthenium, a ruthenium alloy or a ruthenium/molybdenum eutectic.

6. The current bushing system as claimed in claim 1, the coating having at least one oxide from the group consisting of zirconium oxide, yttrium oxide, titanium oxide or a mixed oxide.

7. The current bushing system as claimed in claim 1, the coating being applied so as to substantially cover the entire area of the surface of the current bushing system or individual surface areas being kept free.

8. The current bushing system as claimed in claim 1, the coating being applied with different layer thicknesses on the current bushing system.

9. The current bushing system as claimed in claim 1, the coated surface comprising a mixture of the base material and the coating material.

10. The current bushing system as claimed in claim 1, the coating being applied to the current bushing system by means of a vacuum coating process, in particular by means of a sputtering process.

11. The current bushing system as claimed in claim 1, the coating being applied to the current bushing system by means of an electroplating process or using sandblasting technology.

12. A lamp, in particular a high-pressure discharge lamp, having at least one current bushing system as claimed in claim 1.

13. The current bushing system as claimed in claim 2, the coating of the power supply lines and/or electrodes essentially having a layer thickness of approximately 200 to 400 nm, preferably of 300 nm.
